(19) United States
(12) Patent Application Publication
(10) Pub. No.: US 2018/0226091 A1
(43) Pub. Date: Aug. 9, 2018

(54) Dual Actuator Hard Disk Drive

(71) Applicant: Agency For Science, Technology And Research, Singapore (SG)

(72) Inventors: Chye Chin TAN, Singapore (SG); Weiya XI, Singapore (SG); Chao JIN, Singapore (SG); Zhi Yong CHING, Singapore (SG)

(21) Appl. No.: 15/506,689

(22) PCT Filed: Oct. 2, 2015
(86) PCT No.: PCT/SG2015/050362

§ 371 Date: Feb. 24, 2017

(30) Foreign Application Priority Data
Oct. 2, 2014 (SG) 10201406285R

(51) Int. Cl. G11B 5/55; G06F 12/02; G11B 5/48

(52) U.S. Cl. CPC G11B 5/5578; G11B 5/4813; G06F 12/0223

(57) ABSTRACT

Described are systems and methods for implementation in relation to hard disk drives. The disclosure is direct, at least in part, to a method for writing data in a multiple actuator multiple disk system, and the multiple actuator disk system for performing that method. The method comprises receiving the data and dividing the data into at least a first predetermined portion and a second predetermined portion. The method also includes and writing the first predetermined portion of the data onto a first disk surface of the multiple actuator multiple disk system using a first actuator of the multiple actuators while writing the second predetermined portion of the data onto a second disk surface of the multiple actuator multiple disk system using a second actuator of the multiple actuators.

### FIELD OF THE INVENTION

The present invention relates to the field of Hard Disk Drives (HDD). In particular, it relates to HDD with dual actuators.

### BACKGROUND

The read/write mechanism in a conventional Hard Disk Drive (HDD) generally comprises a voice coil motor controlling a single actuator.

The single actuator arm in the conventional HDD supports one actuator arm. Each actuator consists of one or more actuator arms, one or multiple voice coils, each with or without bobbin, and one pivot cartridge bearing assembly. Each actuator arm forms the mount for a suspension, the suspension having one or multiple read-write magnetic recording heads. During a read/write operation, the voice coil motor moves the actuator arm to position the read/write magnetic heads at a target location on a magnetic disk platter. The read/write operation is then performed at the target location.

Current research is directed towards increasing the data transfer rate of HDDs. Various methods of increasing the data transfer rate of the conventional HDDs have been proposed, including increasing the Rotations Per Minute (RPM) of the magnetic disk platter. While these methods provide a viable option for increasing the data transfer rate, they have several disadvantages. For instance, the cost of a spindle motor with increased RPM capability is high due to complex bearing designs. This increases the manufacturing cost for these HDDs, which is passed on to the consumer. Moreover, HDDs performing at high RPMs generate more heat, which is detrimental to the hard disk drive platter. Without an efficient cooling mechanism in place, a HDD performing at high RPMs would be more susceptible to hard disk drive failure. Furthermore, increasing the RPM of the magnetic disk platter increases vibration of the Head Stack Assembly (HSA) due to turbulent air flow within the HDD. Vibrations in the HSA also jeopardize the recording reliability of the HDD.

Thus, what is needed is a robust read/write mechanism in the HDD that is able to increase the data transfer rate of the HDD while maintaining low RPM of the magnetic disk platter. Other desirable features and characteristics will become apparent from the subsequent detailed description and the appended claims, taken in conjunction with the accompanying drawings and this background of the disclosure.

### SUMMARY

According to the present disclosure there is provided a method for writing data in a multiple actuator multiple disk system, the method comprising:

receiving the data;

dividing the data into at least a first predetermined portion and a second predetermined portion; and

writing the first predetermined portion of the data onto a first disk surface of the multiple actuator multiple disk system using a first actuator of the multiple actuators while writing the second predetermined portion of the data onto a second disk surface of the multiple actuator multiple disk system using a second actuator of the multiple actuators.

According to the present disclosure there is also provided a method for reading data in a multiple actuator multiple disk system, the method comprising:

receiving information on where the data is stored;

reading a first predetermined portion of the data from a disk surface of disk of the multiple actuator multiple disk system using a first actuator of the multiple actuators while reading the second predetermined portion of the data from a disk surface of a disk of the multiple actuator multiple disk system using a second actuator of the multiple actuators; and

combining at least the first predetermined portion of the data with the second predetermined portion of the data.

According to the present disclosure there is yet provided a method for reading read-data and writing write-data in a multiple actuator multiple disk system, the method comprising:

receiving information on where the read-data is stored, the read-data comprising a first predetermined portion;

reading the first predetermined portion of the read-data from a first disk surface of a disk of the multiple actuator multiple disk system using a first actuator of the multiple actuators;

receiving write-data comprising the first predetermined portion; and

writing the first predetermined portion of the write-data on a second disk surface of a disk of the multiple actuator multiple disk system using a second actuator of the multiple actuators.

According to the present disclosure there is provided a method for writing data in a multiple actuator multiple disk system, the method comprising:

receiving first data from a first interface;

receiving second data from a second interface; and

writing the first data onto a first disk surface of a disk of the multiple actuator multiple disk system using a first actuator of the multiple actuators coupled to the first interface while

writing the second predetermined portion of the data onto a second disk surface of a disk of the multiple actuator multiple disk system using a second actuator of the multiple actuators coupled to the second interface.

The present disclosure also provides a method for reading data in a multiple actuator multiple disk system, the method comprising:

receiving information on where the data is stored;

reading a first data from a first disk surface of a disk of the multiple actuator multiple disk system using a first actuator of the multiple actuators coupled to a first interface while

reading a second data from a second disk surface of a disk of the multiple actuator multiple disk system using a second actuator of the multiple actuators coupled to a second interface; and

combining at least the first data and the second data.

The present disclosure still further provides a method for writing data in a multiple actuator multiple disk system, the method comprising:

receiving first data from a first interface;

receiving second data from a second interface; and

writing the first data onto a first disk surface of a disk of the multiple actuator multiple disk system using a first actuator of the multiple actuators coupled to the first interface while

writing the second predetermined portion of the data onto a second disk surface of a disk of the multiple actuator multiple disk system using a second actuator of the multiple actuators coupled to the second interface.

The present disclosure yet provides a method for reading data in a multiple actuator multiple disk system, the method comprising:

receiving information on where the data is stored;

reading a first data from a first disk surface of a disk of the multiple actuator multiple disk system using a first actuator of the multiple actuators coupled to a first interface while

reading a second data from a second disk surface of a disk of the multiple actuator multiple disk system using a second actuator of the multiple actuators coupled to a second interface; and

combining at least the first data and the second data.

The present disclosure also provides a single enclosure multi disk Hard Disk Drive (HDD) comprising:

a first disk surface;

a second disk surface;

a first actuator for writing to the first disk surface; and

a second actuator for writing to the second disk surface, the second actuator separately located and operating independently of the first actuator,

wherein a logical block address (LBA) for the first disk surface is assigned differently than a LBA for the second disk surface, such that the LBA for the second disk surface can be determined from the LBA for the first disk surface.

### BRIEF DESCRIPTION OF THE DRAWINGS

The accompanying figures serve to illustrate various embodiments and to explain various principles and advantages in of HDDs and methods applicable thereto, as described herein.

FIG. 1A and FIG. 1B illustrate top perspective drawings of a Hard Disk Drive (HDD) with dual actuators.

FIG. 2A to FIG. 2I illustrate actuator arrangements for a dual actuator dual system.

FIG. 3A to FIG. 3C illustrate top perspective drawings of single interface and dual interface HDDs.

FIG. 4 is a flowchart representing a write process.

FIG. 5 is a flowchart representing a read process.

FIG. 6A to FIG. 6C illustrate Logical Block Address (LBA) assignments in a multiple actuator, multiple disk Hard Disk Drive (HDD).

FIG. 7 provides a schematic representation of a system providing the HDD as taught by FIG. 1.

Skilled artisans will appreciate that elements in the figures are illustrated for simplicity and clarity and have not necessarily been depicted to scale. For example, the dimensions of some of the elements in the block diagrams or flowcharts may be exaggerated in respect to other elements to help to improve understanding of the present embodiments.

### DETAILED DESCRIPTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Although the systems and methods described herein can be used on a variety of different types of data files, the exemplary data files described herein will be text files, video files, audio files, compressed files, image files, files of various formats (e.g. XML, HTML) and combinations thereof. Each data file can be sent as a single file and segmented (e.g. divided into a first predetermined portion of data and a second predetermined portion of data) by a smart interface in the system, which will hereinafter be referred to as a hard disk drive (HDD), or may be sent as one or more segments. The one or more segments may be received at the HDD interface in the same manner as a complete file.

Unless otherwise specified, reference to a method step is intended to also infer program code capable of causing a computer to executed that method step, and thus also to a computer system capable of performing the method step.

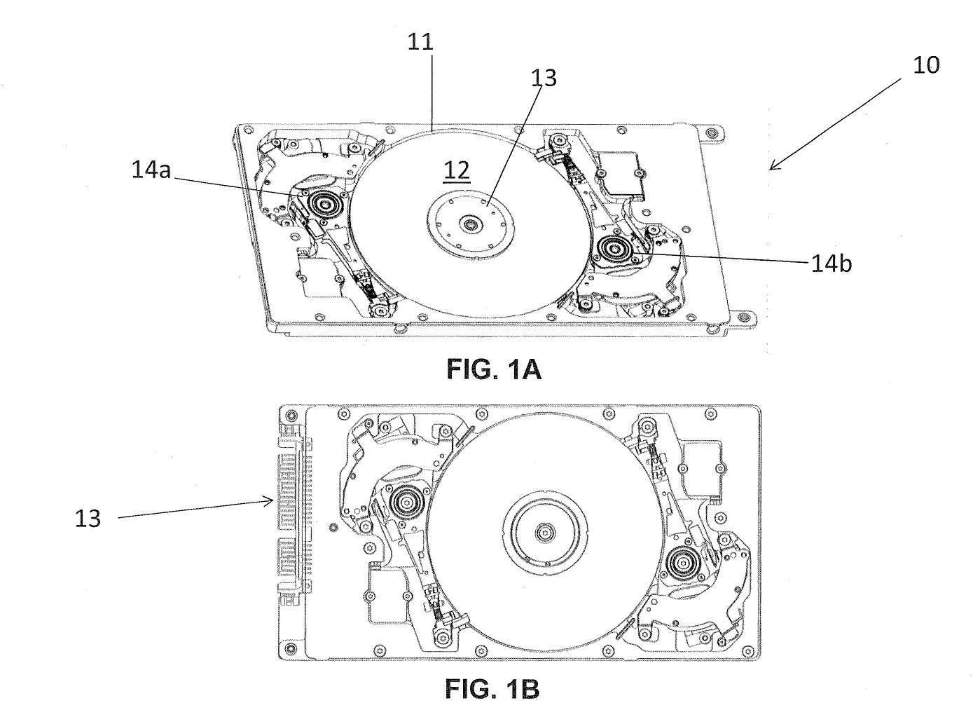

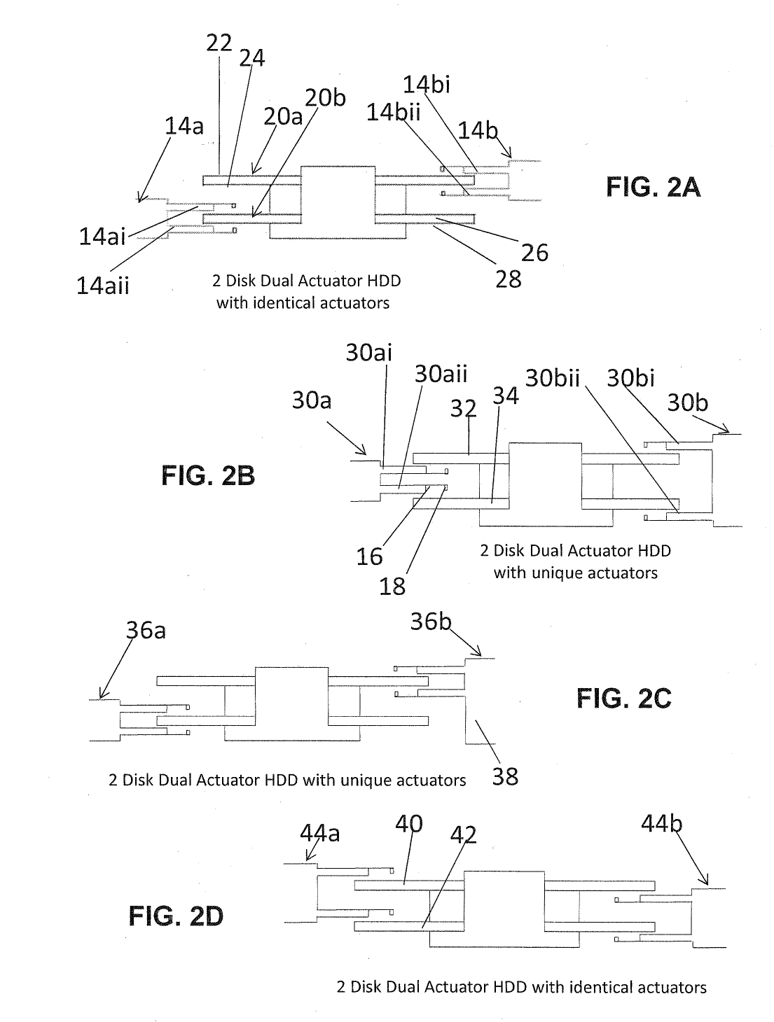

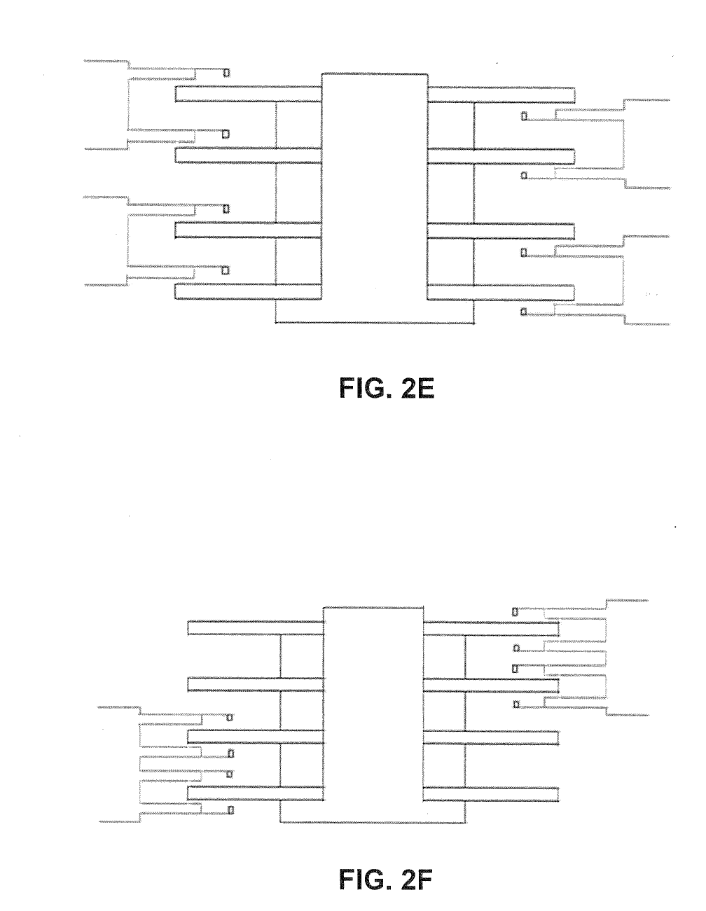

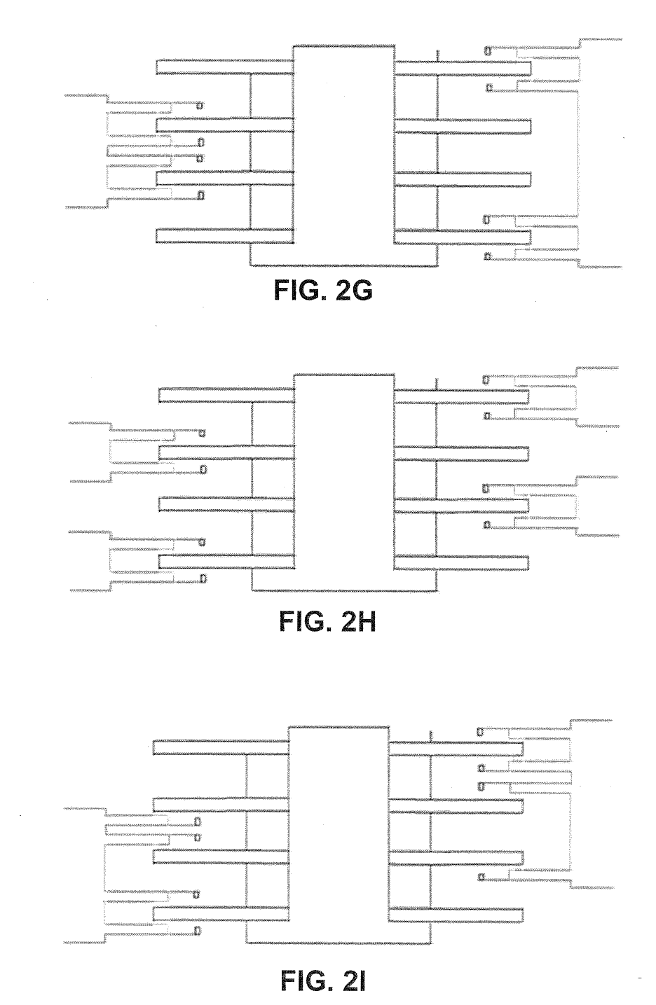

A multiple actuator HDD 10 according to an embodiment of the invention is shown in FIGS. 1A and 1B. The HDD 10 includes a plurality of hard disks 11 forming a stack 12 mounted to a spindle motor hub 13. Each disk 11 has a magnetic coating. The HDD 10 comprises two actuators 14a, 14b, each of which has a plurality of actuator arms 14ai, 14aii, 14bi, 14bii as shown in FIG. 2A. Each actuator arm 14ai, 14aii, 14bi, 14bii supports a respective suspension 16 at the end of which is one or more read/write heads 18.

The form factor selected for the HDD may be any desired form factor. For example, the form factor may be a 3.5 inch form factor in which the length of the HDD is approximately 147 mm, the width is approximately 101.6 mm and the height is approximately 26 mm. The disks 20a, 20b in the stack 12 may be 2 inch disks between which is a space for one or more actuator arms.

As shown in FIG. 1B the HDD 10 has a single input/output (I/O) interface 13 through which data is received and sent to the actuators 14, and from which data is received from the actuators 14 and sent elsewhere.

With reference to FIGS. 2A to 2D, the actuators may provide various configurations of arms. In FIG. 2A, actuators 14a, 14b each include two arms 14ai, 14aii, 14bi, 14bii. A first disk 20a provides two opposed surfaces 22, 24, and a second disk 20b also provides two opposed surfaces 26, 28. In each case, a single read/write head of one of the actuators is positioned with respect to each surface such that the other actuator has no read/write head in the vicinity of the respective surface. For example, for disk 20a, arms 14bi, 14bii and actuator 14b are positioned with respect to respective surfaces 22, 24 so as to facilitate reading and writing from/to those surfaces 22, 24. Similarly, for disk 20b, arms 14ai, 14aii and actuator 14a are positioned with respect to respective surfaces 26, 28 so as to facilitate reading and writing from/to those surfaces 26, 28. Where a read/write head 18 of one actuator is positioned for reading and writing from/to a respective surface, the other actuator does not have any read/write head positioned to read from or write to that surface.

Whereas the actuators 14a, 14b of FIG. 2A are identical, FIG. 2B shows an alternative arrangement in which the actuators 30a, 30b are unique. Actuator 30a provides two actuator arms 30ai, 30aii that extent between the disks 32, 34, and support read/write heads for reading from/writing to respective bottom and top surfaces of those disks 32, 34. In contrast, the read/write heads supported by arms 30bi, 30bii read from/write to opposed respective top and bottom surfaces of those disks 32, 34.

In addition, where the actuators 14a, 14b of FIG. 2A each serviced a respective disk 20a, 20b, each disk 32, 34 of FIG. 2B is serviced by a read/write head from each of the actuators 30a, 30b.

FIG. 2C provides an arrangement similar to that of FIG. 2A, except that the actuators 36a, 36b are unique. Actuator 36a is similar to actuator 14a. However, actuator 36b includes an extended motor shaft 38.

FIG. 2D shows an arrangement similar to FIG. 2B, in that each disk 40, 42 is serviced by a read/write head from each actuator 44a, 44b. However, where the arrangement of FIG. 2B requires unique actuators 30a, 30b, the arrangement of FIG. 2D makes use of identical actuators 44a, 44b, albeit it one actuator 44a, 44b inverted with respect to the other actuator 44a, 44b.

FIGS. 2E to 2I show further actuator arrangements in which each actuator provides four actuator arms. In practice, the concept illustrated in FIGS. 2A to 2D can be scaled to accommodate any suitable number of disks, with a separate read/write head servicing each surface of each disk. Notably, FIGS. 2E, 2F and 2H show arrangements in which identical actuators can be employed, whereas FIGS. 2G and 2I provide arrangements in which the actuators are unique.

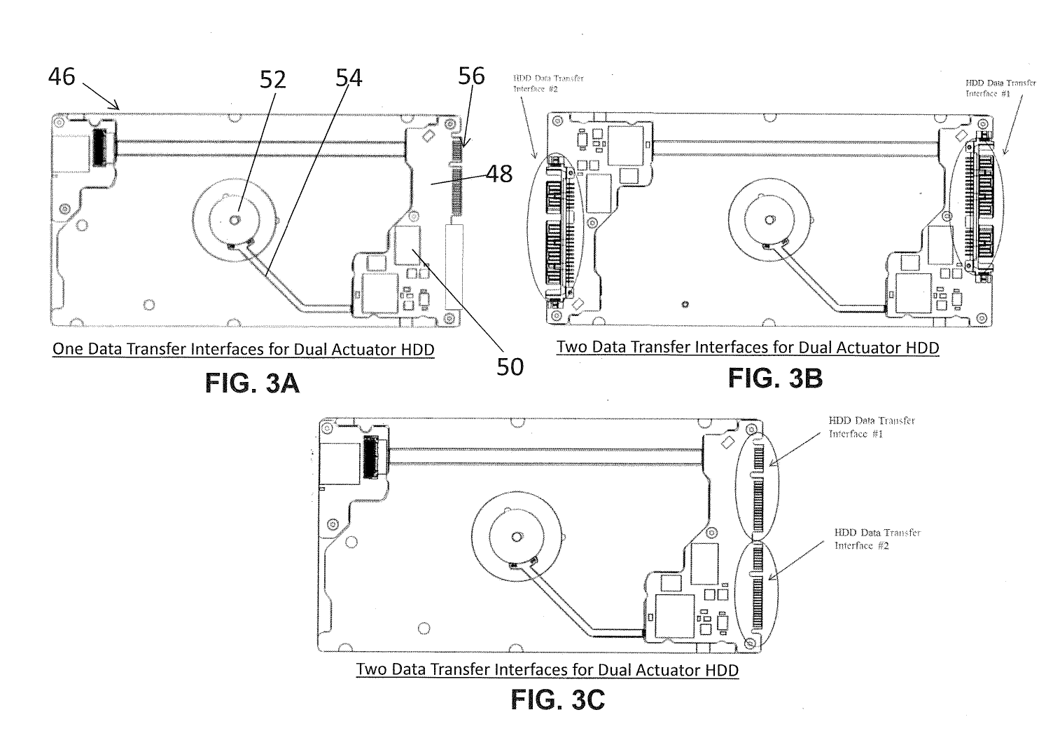

With reference to FIGS. 3A to 3C, an HDD in accordance with present teachings may employ a single interface, two interfaces or three or more interfaces through which data is received for writing to the stack 12 and through which data read from the stack 12 can be transmitted.

The arrangement shown in FIG. 3A provides a HDD 46 comprising a single interface 48. The single interface 48 receives a data file (e.g. a text file, sound file or video file) to be written by both actuators (not shown) and disseminates the data constituting that data file to the multiple actuators. The single interface 48 also instructs the actuators to read data from the stack 12 from which it can reconstruct the data file for transmission from the HDD, and controls rotation of the spindle motor hub 52 to which the disks are mounted.

The single interface 48 is a smart interface. The smart interface 48 comprises a computer-readable medium 50 having computer program code stored thereon. The computer program code controls the smart interface 48 to ensure that data files are accurately disseminated and reconstructed, and to ensure references (e.g. pointers) to data in the stack 12 such that the data can be located in future. The references may be stored in the interface 48 or remotely from the HDD. Alternatively, the computer program code for controlling the smart interface 48, and other firmware codes for operating the HDD, can be stored in a non-volatile stage space inside the HDD. Such firmware codes may be stored on magnetic media such as a disk 11.

When a data file arrives, the smart interface 48 determines where to store that data file and sends a signal to the spindle motor hub 52 to commence spinning in a particular direction. Where a surface of a disk in the stack 12 is serviced by more than one actuator arm, and thus more than one read/write head, the closest read/write head to the location at which the smart interface 48 determines a file should commence being written will be ½ N, where N is the number of actuator arms servicing the particular disk surface. Thus for a dual actuator arrangement (i.e. two actuators) where each actuator has an arm servicing a particular disk surface, the closest read/write head on the respective arm will be at most ¼ revolution of the disk away from that read/write head.

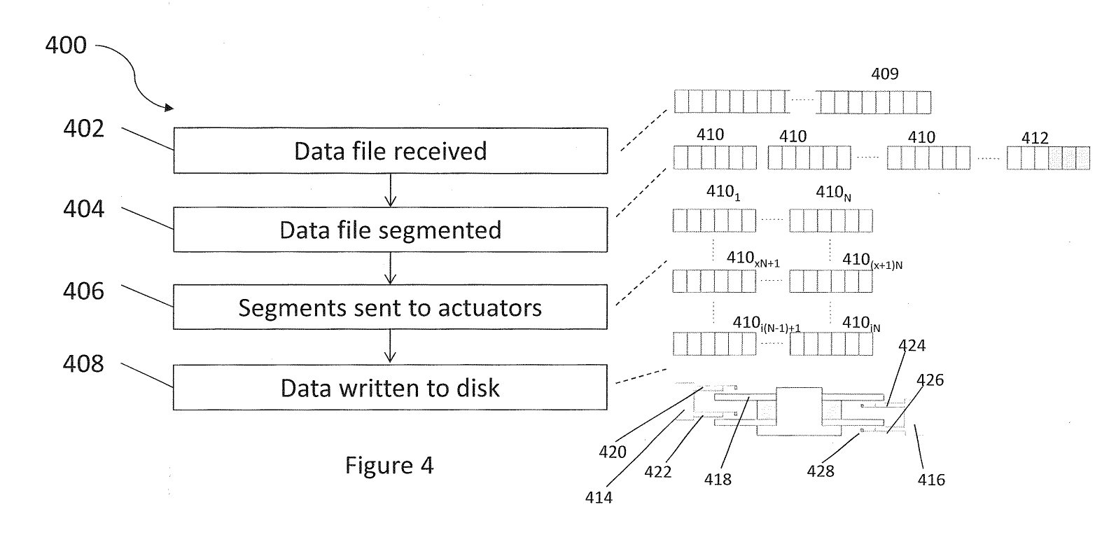

With reference to FIG. 4, a process for disseminating a file is shown. It will be appreciated that any particular file dissemination process may be used. For example, for a configuration complying with a Redundant Array of Inexpensive/Independent Disks (RAID) level 0 (i.e. data striping with no parity information), the following write process 400 may be applied:

Step 402: data file received (write-data—may comprise one or more segments or predetermined portions).

Step 404: data file progressively segmented.

Step 406: segments sent to actuators.

Step 408: data written to disk.

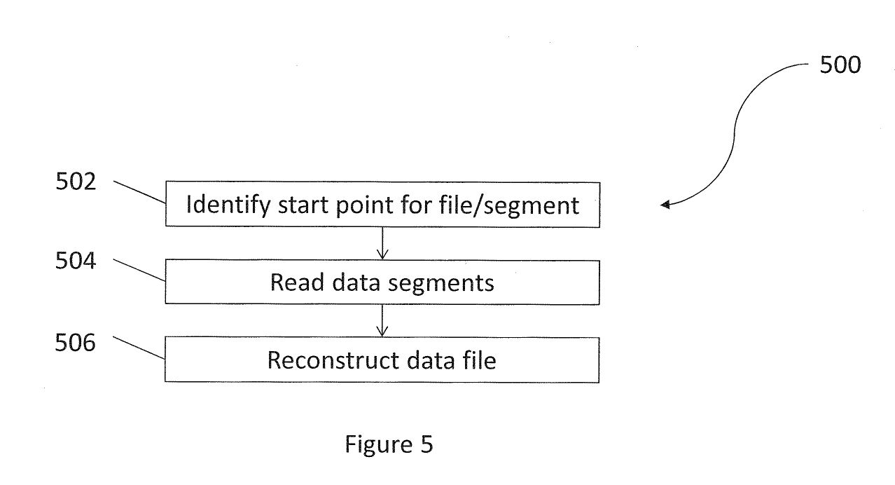

A read process 500 may also be applied by the smart interface 48 as shown in FIG. 5. For a RAID0 storage configuration, the read process 500 may involve:

Step 502: identifying a start point for a desired data file or segment (read-data—may comprise one or more segments or predetermined portions).

Step 504: progressively reading data segments.

Step 506: reconstructing the data file.

With further reference to FIG. 4, step 402 involves receiving a data file 409 through the port 56 (see FIG. 3A). The data file may comprise a text file, video file, audio file or any other file type.

The interface 48 then deconstructs or segments the file at step 404. Segmentation may involve dividing the file into segments 410 of equal size. For a RAID0 storage configuration, the segments are necessarily of equal size. Where the data file 409 is not exactly divisible into segments the final segment 412, which will be shorter than segments 410, can be padded as indicated by the shaded bytes. The size may be determined using various approaches. Since the smart interface 48 reconstructs the data file from the segments, one approach would be to select a segment size that can be combined by the smart interface during subsequent read processes in the time taken for a segment to be read by one of the actuators. In other words, after each actuator has sent a respective segment to the smart interface, the smart interface will finish combining those segments in the same time as would be taken for the actuators to read and send a further segment to the smart interface. Thus the actuators and smart interface have approximately 100% utilisation during read/reconstruction processes.

For other storage methodologies, the data file may be segmented in other ways. For example, the data file may be segmented or otherwise disseminated according to any other methodology.

Once segmented, the file segments are sent to the actuators 414, 416 per step 406. As shown in FIG. 4, the segments are split up and sent to each actuator in turn—the distribution of segments may change depending on the RAID configuration, or other storage regime, the type of file and so forth. FIG. 4 shows a circumstance in which N actuators are provided, wherein the (x+1)^{th} segment is given to the first actuator, for x between 0 and N−1. Similarly, every N^{th} segment is sent to the N^{th} actuator. In line with a RAID0 storage configuration and with reference to the two actuators of the dual actuator arrangement in FIG. 4, the actuators 414, 416 are each sent segments in sequence. For example, where there are two actuators 414, 416, one actuator 414 is sent the first segment (i.e. first predetermined portion of the data file), the other actuator 416 is sent the second segment (i.e. first predetermined portion of the data file), actuator 414 is sent the third segment, actuator 416 is sent the fourth segment and so on.

Each actuator 414, 416 is also provided with a pointer identifying the location for writing the respective segment. This informs the respective actuator 414, 416 of:
i) the appropriate actuator arm 420, 422, 424, 426 to send the segment to;
ii) where that arm 420, 422, 424, 426 supports more than one read/write head 428, the particular read/write head to send that segment to; and
iii) where to position the actuator arm 420, 422, 424, 426 such that the read/write head 428 is located over the correct track on the surface of the disk 418.

In traditional storage methodologies employing, for example, a RAID0 storage configuration the segments would have been distributed across multiple disks. The storage configuration is thus implemented by an external source (e.g. CPU) sending the respective segments to multiple HDDs. Each HDD thus receives its respective segment and treats that segment as a complete data file for storage purposes. In other words, no further segmentation of the segment is made by the HDD.

In the present embodiment, the HDD performs the segmentation using the smart interface 48. Thus the smart interface 48 treats the single stack 12 of disks as multiple separate storage facilities each serviced by a respective actuator. Controlling the reading and writing in this manner enables a RAID storage methodology to be implemented on disks.

This methodology uses the stack 12 of a one dual actuator HDD in the same manner as would be the use of multiple HDDs, is enhanced by the provision of only a single actuator arm for servicing each disk surface. Thus the set of disk surfaces serviced by the actuator arm(s) of actuator 414 is unique to, and does not non-overlap, the set of disk surfaces serviced by the actuator arm(s) of actuator 416.

Indexing of positions for storing data on the surfaces of the disks in the stack 12 may follow any desired indexing regime. For example, a standard byte addressing regime may be used for indexing (i.e. addressing or locating) individual bytes of data on the disk surfaces. However, it is envisaged that the smart interface 48 will be suited to efficient storage of large blocks of data. Thus a logical block address (LBA) regime may be used instead of a byte addressing regime. According to LBA techniques, a single number is used to address a block of data (e.g. a segment created under step 404).

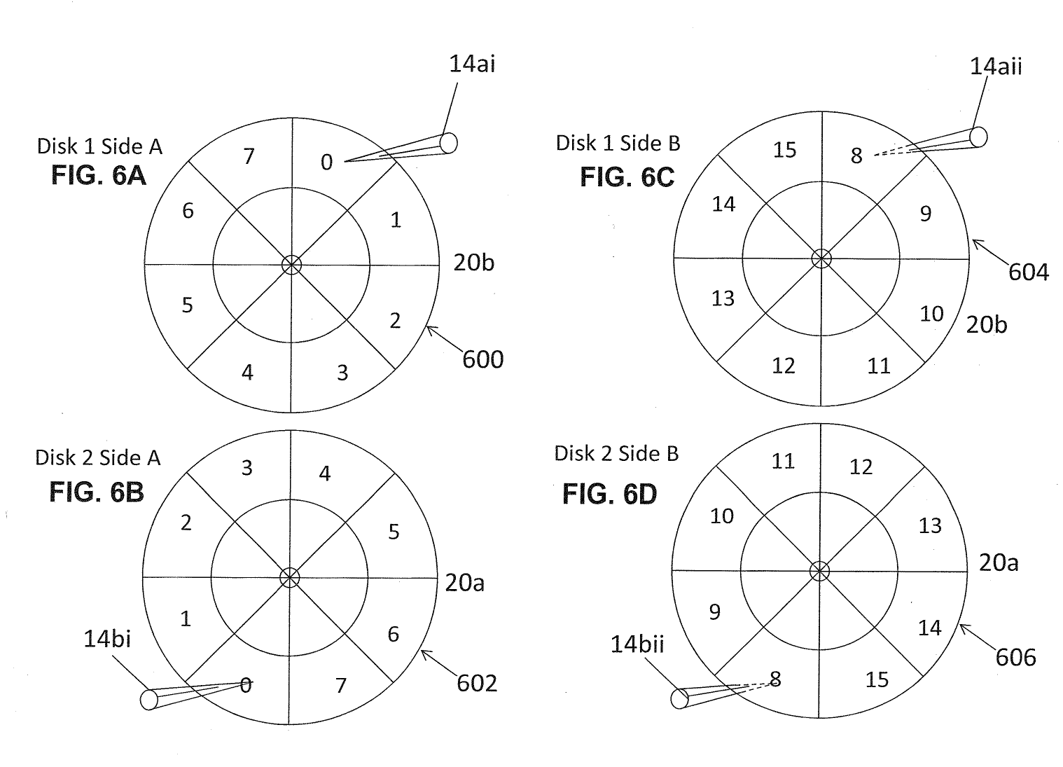

An exemplary use of a LBA regime is illustrated with reference to FIGS. 6A to 6D, that show a schematic illustration of the actuator and disk arrangement of FIG. 2A. Each disk surface 600, 602, 604, 606 is divided into a number of sectors 608. Presently there are 8 such sectors although any desired number may be employed. Moreover, the sizes of the segments created in accordance with step 404 may be selected to be equal to the maximum segment capable of being stored in the respective disk sector.

In FIGS. 6A to 6D:
the upper side 600 of disk 20b is serviced by actuator arm 14ai of actuator 14a;
the lower side 604 of disk 20b is serviced by actuator arm 14aii of actuator 14a;
the upper side 602 of disk 20a is serviced by actuator arm 14bi of actuator 14b; and
the lower side 606 of disk 20a is serviced by actuator arm 14bii of actuator 14b.

Using the LBA regime data is sequentially written (or read from) sectors of the disk. For example, a first segment 410 may be sent to arm 14ai for writing onto surface 600; a second segment 410 may be sent to arm 14bi for writing onto surface 602; a third segment 410 may be sent to arm 14aii for writing onto surface 604; and a fourth segment 410 may be sent to arm 14bii for writing onto surface 606. Notably, this segmentation writing scheme uses the stack 12 in the same way as four separate HDDs, according to a RAID0 storage configuration.

For the shortest possible read/write time it may be desirable that the data to be read, or the location at which data is to be written, is beneath the read/write head of each respective arm 14ai, 14aii, 14bi, 14bii at the time the data is to be read or written. In the present embodiment, the smart interface 48 indexes the positions for writing data such that the respective writing position for each actuator arm 14ai, 14aii, 14bi, 14bii is simultaneously beneath the read/write head of the respective arm 14ai, 14aii, 14bi, 14bii.

In the present, dual actuator, embodiment the smart interface 48 locates the segments such that the positioning of any one of the actuator arms 14ai, 14aii, 14bi, 14bii is related to the positions of one or more other actuator arms 14ai, 14aii, 14bi, 14bii. In other words, the location of one actuator arm 14ai, 14aii, 14bi, 14bii can be determined form the location of one or more other actuator arms. Moreover, the positions of each actuator arm 14ai, 14aii, 14bi, 14bii are relatively offset by an amount equal to 2π/M where 2π is the number of radians in a full circle, and M is the number of actuators. Thus, for a dual actuator system as shown the offset between the actuator arms 14ai, 14aii, 14bi, 14bii will be π radians, or 180°.

As shown in FIGS. 6A to 6D, the 0^{th} sector of disk surface 600 is offset by 180° to the 0^{th} sector of disk surface 602. Also, the 8^{th} sector of disk surface 604 is offset by 180° to the 8^{th} sector of disk surface 606. Moreover, the 8^{th} sector of disk surfaces 604, 606 are directly beneath the respective 0^{th} sector of surfaces 600, 602. This enables the smart interface 48 to store a single location in memory, to identify multiple data segments.

In line with step 406, data segments are sent to each actuator 414, 416. In particular each actuator receives, substantially simultaneously, data to be written by each read/write head of each actuator arm 14ai, 14aii, 14bi, 14bii. With at least one of the segments, a position index is provided by which the actuator 414, 416 can position its arms 14ai, 14aii, 14bi, 14bii to write the data to the disk 20a, 20b. Since each of the arms 14ai, 14aii, 14bi, 14bii for each actuator are rotated to the same position, only a single position index is required. Moreover, since the offset between the positions of actuator arms 14ai, 14aii of actuator 14a is constant, the positions of actuator arms 14bi, 14bii can be determined using the same position index.

Once the segments are sent to the actuators 14a, 14b, the actuators simultaneously write to their respective disk surfaces 600, 602, 604, 606 through all read/write heads involved in writing of the file. This process works particularly well for a RAID0 storage configuration since that configuration attempts to keep the number of data segments from each file, stored on each HDD, equal.

While there are advantages with regard to speed of writing (and reading, as discussed below), using the present teachings, the consistent location of all actuator arms 14ai, 14aii, 14bi, 14bii relative to their respective disk surfaces 600, 602, 604, 606 also equalises the forces applied to each arm 14ai, 14aii, 14bi, 14bii, to the extent possible. This ensures location error detection and other corrective measures can be applied uniformly to all actuator arms 14ai, 14aii, 14bi, 14bii.

The smart interface 48 may also distribute segments of the data file across the disk surfaces depending on the ability of the data file to be reconstructed. In other words, segments of the data file may be distributed based on the type of data file. For example, a text file can be easily reconstructed and thus can be segmented and written to multiple disk surfaces. By way of contrast, it can be more desirable that segments of a video file be stored close to each other—for example on the same disk surface—to facilitate error-free reconstruction.

With reference to FIG. 5, the read process 500 involves identifying a start point for a desired data file, per step 502. To do this, the smart interface 48 may look up the location of the start of each data segment from memory in the interface 48 or memory maintained remotely. In the embodiment described with reference to FIGS. 6A to 6D, the smart interface 48 need only look up a single location from memory. That single location indicates the start position of a data segment for one of the actuator arms. However, since the actuator arms write data to common sectors or to sectors located at a common vertical position on a disk (i.e. at the same location albeit on opposite sides of a disk), extracting from memory the location of the start of a single data segment will enable all actuator arms to be appropriately located, thereby enabling reading from the read/write head of each actuator arm simultaneously. Therefore, identifying a start point for a desired data file in memory may comprise extracting a single reference and forwarding the single reference to each actuator. This enables one or more arms of each actuator to be positioned at the start of respective data segments from which the data file can be reconstructed. Preferably, the single reference will enable two or more arms of each actuator to be positioned at the start of respective data segments from which the data file can be reconstructed.

Once the actuator arms have been so positioned as a result of step 502, the data segments are progressively read per step 504. Progressive reading may involve the sequential reading of data segments from each actuator (through a read/write head thereof), or actuator arm, in turn. However, where the single reference is used to position more than one actuator arm at the start of a respective segment of the data file, progressively reading data segments involves simultaneously reading a data segment through each actuator arm so positioned. The data segment read through one actuator arm will be different from the data segment or segments read through the other actuator arm or arms. Moreover, the data segments simultaneously read by the arms should collectively comprise a continuous section of a data file. In other words, if the data segments were to be concatenated they would constitute a continuous section of data from the data file being reconstructed by the read process 500.

Once each read/write head of each actuator arm has finished reading a segment, the smart interface 48 provides a new reference by which the actuators can positioned their respective arms for reading the next segment or group of segments. The term ‘group of segments’ refers to the segments simultaneously read by the collection of actuator arms the read/write heads of which are performing a read operation at that relevant point in time. As an alternative to providing a new reference, position information may be written to the disk (e.g. a one or more bytes at the end of a segment or on a position data layer of the respective disk) to enable the actuator arms to reposition upon reaching the end of the respective segment. A further alternative would be that the read/write heads continue to read through the next disk sector at the same distance from the axis of rotation of the disk (i.e. the read/write heads do not move), until all relevant sectors have been read, and then the actuator arm supporting the respective read/write head is moved as needed.

Where the smart interface 48 sends the indexes, pointers or other reference data for locating files and segments of files on the disks in the stack 12, that reference data may be stored by the smart interface 48 either locally (i.e. within the HDD) or remotely. For speed performance, it is desirable that the reference data be located locally.

Once the segments have been read by the read/write heads, they are transmitted to the smart interface 48. The smart interface then reconstructs the data file. Where the data file is large and requires multiple reads from one or more of the actuators, the data file is progressively reconstructed as each read process is performed by each read/write head. The smart interface 48 then sequentially concatenates the segments to reconstruct the data file.

Once reconstructed, the data file is sent from the single interface in the same manner as would be the case if a request was made to a single interface interfacing with a HDD that did not perform any data segmentation. In this manner, a computer system can use the HDD shown in FIGS. 2A to 2D to store large data files without having to segment those files for storage in separate storage media.

The smart interface 48 may also control one of the actuators 14a, 14b to perform a write operation concurrently with controlling the other actuator 14a, 14b to perform a read operation. Where the arms 14ai, 14aii, 14bi, 14bii of the actuators 14a, 14b each read to and write from a unique surface (i.e. each disk surface is serviced by a single actuator arm only), there is no conflict between the tracks, segments or sectors be written to and those being read from. In addition, a backup can be created within the HDD where, for example, data read from one disk surface during a read operation is written (e.g. concurrently) to a different disk surface during a write operation. The read and write may be performed by the same actuator 14a, 14b or by different actuators 14a, 14b.

FIGS. 3B and 3C show two embodiments of a dual interface HDD. The dual interface HDD provides two data interfaces for receiving data from two sources. Alternatively, the data may be received from the same source and be treated in the same manner as two separate HDDs.

Since the read/write heads of the arms of one actuator read and write (i.e. service) different disk surfaces to the read/write heads of the arms of the other actuator, the disk surfaces serviced by one actuator form, in effect, a first storage device (e.g. a first HDD) and the surfaces serviced by the second actuator form, in effect, a second storage device (e.g. a second HDD). Using this arrangement, a single HDD comprising M actuators can be used to replicate M separate storage devices.

Data may be written through, or read through, each interface in the same manner as would be the case for reading/writing to multiple HDDs. Alternatively, the two interfaces may communicate such that, for a particular data file segments of which are sent to both interfaces, the actuator arms accessible through each interface are relatively positioned for writing—in the same manner as set out in relation to FIGS. 6A to 6D—such that subsequent read operations or processes result in data segments being delivered through both interfaces substantially simultaneously.

A similar methodology may be used for the relative positioning of actuator arms to read data segments from files that are related in a manner that would result in them often being read concurrently. For example, a file defining a screen layout for presenting data might be read through one interface while data defining a desired presentation scheme (e.g. colours, menu options and the like) might be concurrently read from the second interface.

Each data interface may also be capable of controlling multiple actuators such that the two interfaces control four or more actuators. Alternatively, each interface may be a smart interface with one interface interacting with a first computing system and a second interface interacting with a second computing system. This enables the HDDs of FIGS. 3B and 3C to map instructions received from disparate computing systems to the same storage architecture. Thus each interface is capable of sending read and write commands to all of the actuators in the HDD (e.g. the two actuators in the present dual actuator HDD) in the same manner as described above in relation to FIGS. 4 to 6.

In addition, the interfaces may communicate such that when one interface is reading or writing, the other interface waits to perform a read or write process. This ensures there are no conflicting read or write instructions. The interfaces may also communicate to determine which interface is requesting data to be read from, or written to, parts of the disks (e.g. sectors or tracks) that are closer to the current positions of the read/write heads than the parts of the disks sought to be read from or written to by the other interface. Thus data is read or written depending on proximity to the current positions of the read/write heads. This methodology therefore optimises the overall read/write time for the HDD across multiple interfaces.

So that the same file can be read through both smart interfaces, the smart interfaces may use a common library or common storage medium for storing position data by which to position the respective actuator arms of the actuators for reading and writing. When a file is written, the library or storage medium is updated with the new file position or indexing data that can be referenced through both interfaces.

Using the control methodologies discussed above, the two interfaces can separately be used to control all actuators in a HDD. The HDD can therefore serve as a storage medium for storing data using disparate formats and dissimilar, albeit storage regimes provided the different formats and regimes do not result in conflicting storage or reading. For example, one interface should not control the actuators to write over data intended to be accessible through the other interface.

The read and write operations performed using the dual interface, dual actuator HDD may be the same as those for two individual, single actuator HDDS with the exception that specific sectors or tracks may be assigned to one interface to avoids conflicts with data being written through the other interface. That assignment may be fixed—for example, particular sectors or tracks are pre-allocated to each interface. Alternatively, that assignment may be dynamic—for example, sectors or tracks may be allocated on an ‘as needs’ basis until all of the sectors or tracks have been allocated. Upon allocation of a sector or track, that sector or track is removed form accessibility by the other actuator until the data stored thereon is deleted.

Where the two interfaces operate as distinct interfaces the surfaces of the disks in the stack 12 may be allocated to one of the two actuators. Thus the HDD can be used in the same manner as two traditional HDDs being addressed by a computing system or two computing systems. Where the two interfaces each communicate with both actuators, or interact to control the read and write operations performed by the actuators, the actuators may use any standard protocol by which two computing systems would request data from or send data to a single server or memory device. Where the two interfaces each communicate with both actuators, the references (e.g. position indexes) may be stored in a common memory device or library. Where the two interfaces each communicate with both actuators, the interfaces may read and write through the actuators in the same manner as described in relation to FIG. 6 and processes 400 and 500. It will be noted that sector and/or track assignment if necessary to achieve separation of data accessible through one interface that should not be accessible through the other interface.

In any of the above writing processes it will be appreciated that parity information may also be written to the HDD. The parity information may be written to a particular disk surface. In other words, a particular disk surface (or disk for that matter) may be reserved for storing parity information. The parity information enables a determination to be performed of whether there are errors in data being read or written. The parity information can also enable data to be reconstructed where there has been disk, sector or track failure. Where a particular surface is reserved for parity information the storage regime implemented for storing data in the stack 12 may be similar to that employed in RAID level 3 (RAID3) configurations in which a single storage medium of an array of storage media is reserved for parity information.

Since the disks in the stack 12 are all mounted to the same spindle motor hub and thus rotate at the same speed, and the actuators can be controlled to position the arms at the same positions relative to the respective disk surface to which the read/write heads of those arms write and from which they read, the present arrangement may enable the use of RAID level 2 (RAID2). Notably, RAID2 provides extremely high data transfer rates but uses Hamming code for error correction. For multiple HDDs it provides little advantage and is seen as commercially unusable. However, it may be possible to implement successfully in a single HDD in accordance with methodologies described herein. Alternatively, a RAID level 5 (RAID5) may be used to provide a simple XOR (exclusive OR) parity implementation where the HDD buffers data sectors, calculates the parity sector and writes the data and parity sectors to the stack.

Rather than reserving a disk surface for parity information, that parity information may be striped along with the data segments onto the various disk surfaces. The process for data striping and parity writing will be understood by the skilled person, for example from the various RAID level 3 to 6 configurations.

Once parity information has been written to one disk surface, or has been striped along with the data onto multiple disk surfaces, it can be used to identify and potentially correct data errors. The parity information may be computed using an exclusive OR (i.e. XOR) parity scheme. In an XOR parity scheme the data segment—which may be a segment as described above, or a word, string and so forth—contains a known number of bits with a value ‘1’. The XOR parity bit is therefore set to ‘1’ or ‘0’ depending on whether the number of in the data segment is even or odd. Typically, the XOR bit will be set to ‘1’ where to number of ‘1’s in the data segment is even, and ‘0’ where the number of ‘1’s in the data segment is odd. Thus the XOR computation will use a checksum routine providing the parity bit for checking the sum of the ‘1’s in the data segment. In each case, the checksum process should yield a ‘1’ to demonstrate that the XOR computation has been successful and thus the data is accurate (unless there are two bit in the segment with errors, though this is unlikely). A similar process may be used where the desired result of the XOR computation is a ‘0’.

While for RAID0 there is no parity used, for other storage regimes using parity bits the data may be reconstructed even where an error has been detected. Data reconstruction using XOR computation will be understood by the skilled person.

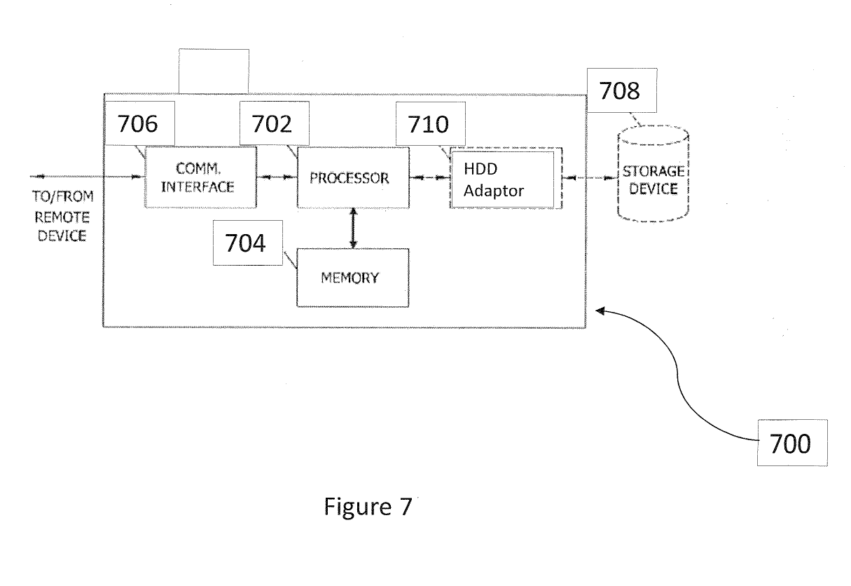

FIG. 7 illustrates an exemplary configuration of a storage interface 700. Storage interface 700 may include a HDD such as a dual actuator HDD as described above.

Computing system 700 also includes a processor 702 for executing instructions. Instructions may be stored, for example, in a memory area 704 or other computer-readable media. Processor 702 may include one or more processing units (e.g., in a multi-core configuration). The memory area 704 may also store a library of indexes or references to the starting locations of data files and file segments on disks within the HDD.

Processor 702 may be operatively coupled to a communication interface 706 such that storage interface 700 is capable of communicating with a remote device such as user computing device or another storage interface 700. For example, communication interface 706 may receive requests from a client system via the Internet.

Processor 702 may also be operatively coupled to storage device 708. Storage device 708 is any computer-operated hardware suitable for storing and/or retrieving data, and presently comprises a stack of magnetic hard disks. In other embodiments, storage device 708 is external to storage interface 700 and/or may be accessed by a plurality of storage interfaces 700 such as would be the case for the dual interface embodiments of FIGS. 3B and 30. For example, storage device 708 may include multiple storage units such as other hard disks or solid state disks in a redundant array of inexpensive disks (RAID) configuration. Storage device 708 may include a storage area network (SAN) and/or a network attached storage (NAS) system.

In some embodiments, processor 702 is operatively coupled to storage device 708 via a HDD adaptor 710. HDD adaptor 710 is any component capable of providing processor 702 with access to storage device 708. HDD adaptor 710 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 702 with access to storage device 708.

In operation, the processor 702, coupled to a memory device (including memory device 704 and storage device 708), reads data from disk surfaces of disks in the HDD 708, writes data to surfaces of disks in the HDD 708, reconstructs data and segments data as described above in relation to FIGS. 4 and 5, and also generates and stores indexes for locating data written to disk surfaces of the HDD 708.

The storage interface 700 may be instructed to perform the read, write, reconstruct, segment and indexing processes by a computer program embodied on a non-transitory computer readable medium, such as memory device 704 or storage device 708. The program stored on the device 704, 708 would include at least one code segment, and most likely many thousands of code segments, executable by a computer to instruct the computer to perform the requested operations. It will be appreciated that routines and programs enabling complex operation of the storage interface 700 with read and write processes involving the HDD 708 may be stored on the HDD 708, for example in a dedicated space, disk or disk surface in the HDD.

Similarly, the program may be stored remotely. To this end, the storage interface 700 may constitute a client computer HDD of a network-based system for executing read, write, segment, reconstruct and indexing operations on a HDD.

The dual actuator HDDs described herein can provide higher data transfer rates than single actuator HDDs at lower revs per minute (RPM). The lower RPM results in less heat generated within the HDD, thus reducing cooling requirements, reducing the likelihood of HDD heat failure and increasing longevity of the HDD. Moreover, by implementing backup (e.g. where one actuator reads from one surface while the other actuator writes the read data to a different surface within the same HDD) redundancy and backup can be achieved without the need for a second HDD.

A dual actuator HDD in accordance with present teachings, may in practice comprise: a singular spindle motor residing on an extended base housing; a singular spinning motor carrying one, two or more magnetic media or disks capable of storing digital information—should a plurality of magnetic media be used, the media may be separated by spacer rings and held in place using a clamping components such as a spring disk clamp, a ring nut or alternative fastening mechanism; two or more actuators, each being a rotary head stack actuator assembly having head sensors each of which accesses a different disk media surface for read/write operations, such that in event that the assignment of head sensor to media surface is dedicated; two voice coil magnet yoke assemblies or voice coil motors (VCM) each of which holds one or two magnets in the upper or/and lower steel yokes and provides electromagnetic actuation when current is passed across the coil windings (which is part of the head stack actuator assembly); two inertia latches with hooks to catch the head stack assemblies in event of a pre-defined shock imparted under non-operating condition; two ramp parking devices for parking and protecting the head stack actuator assemblies outside the disk media periphery when the hard disk is either in low idle or non-operating modes; two electrostatic filters to promote faster particulate cleanup with the hard disk drive, the filters being spaced separately and held by base housing extension that forms shrouding features to minimize turbulence upstream of the head-disk zone; an extended top cover for enclosing the above mentioned components and subassemblies within the base housing, the cover being secured to the base housing periphery using screws or alternative fasteners and having fastening hole features through the head-stack assembly centre-bearings for vibration reduction—optionally, a hole may be provided at the centre of the cover for securing to spindle motor shaft to mitigate resonance and mechanical vibrations; a gasket or an integrated form-in-place gasket (FIPG) on the top cover to seal the hard disk drive from external contaminants or particulates; and one or more absorbent breather or desiccant filter(s) for absorbing gas or vapor contaminants imparted to the drive from components during drive.

The two head stack actuator assemblies may be seated at different heights from each other when assembled on the base housing. They may also be spaced 180° opposite of each other with their centres lined up along the motor centre or may use a different spacing where, for example, three or more actuators are used, or where the stroke and access requirements would be optimised with different spacing. The head stack actuator assemblies may be modular in construction, such that varying arm lengths, arm-to-arm angular spacing can be accommodated.

Many modifications and variations of the present teachings will be apparent to the skilled person in light of the present disclosure. All such modifications and variations are intended to fall within the scope of the present disclosure. Moreover, to the extent possible, features form one of the embodiments described herein may be used in one or more other embodiments to enhance or replace a feature of the one or more other embodiments. All such usage, substitution and replacement is intended to fall within the scope of the present disclosure.

1. A method for writing data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving the data;
dividing the data into at least a first predetermined portion and a second predetermined portion; and
writing the first predetermined portion of the data onto a first disk surface of the multiple actuator multiple disk system using a first actuator of the multiple actuators while writing the second predetermined portion of the data onto a second disk surface of the multiple actuator multiple disk system using a second actuator of the multiple actuators, wherein the second actuator is located separately from the first actuator.

2. The method of claim 1, wherein the dividing step comprises dividing the data to optimize parallel data storage within the multiple actuator multiple disk system.

3. The method of claim 2, wherein dividing the data to optimize parallel data storage within the multiple actuator multiple disk system comprises dividing the data into a plurality of segments of similar size.

4. The method of claim 3, wherein dividing the data into a plurality of segments of similar size may comprise padding at least one of the segments in the plurality of segments to be of equal size to the other segments in the plurality of segments.

5. A method for reading data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving information on where the data is stored;
reading a first predetermined portion of the data from a disk surface of disk of the multiple actuator multiple disk system using a first actuator of the multiple actuators while reading the second predetermined portion of the data from a disk surface of a disk of the multiple actuator multiple disk system using a second actuator of the multiple actuators, wherein the second actuator is located separately from the first actuator; and
combining at least the first predetermined portion of the data with the second predetermined portion of the data.

6. A method for reading read-data and writing write-data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving information on where the read-data is stored, the read-data comprising a first predetermined portion;
reading the first predetermined portion of the read-data from a first disk surface of a disk of the multiple actuator multiple disk system using a first actuator of the multiple actuators;
receiving write-data comprising the first predetermined portion; and
writing the first predetermined portion of the write-data on a second disk surface of a disk of the multiple actuator multiple disk system using a second actuator of the multiple actuators, wherein the second actuator is located separately from the first actuator.

7. The method of claim 6, wherein the reading step and writing step occur at least partially concurrently.

8. The method of claim 6, wherein the read-data comprises a second predetermined portion, the method further comprising reading the second predetermined portion concurrently with writing the first predetermined portion.

9. A method for writing data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving first data from a first interface;
receiving second data from a second interface; and
writing the first data onto a first disk surface of a disk of the multiple actuator multiple disk system using a first actuator of the multiple actuators coupled to the first interface while
writing the second data onto a second disk surface of a disk of the multiple actuator multiple disk system using a second actuator of the multiple actuators coupled to the second interface.

10. A method for reading data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving information on where the data is stored;
reading a first predetermined portion of the data from a first disk surface of a disk of the multiple actuator multiple disk system using a first actuator of the multiple actuators coupled to a first interface while reading a second predetermined portion of the data from a second disk surface of a disk of the multiple actuator multiple disk system using a second actuator of the multiple actuators coupled to a second interface; and
combining at least the first data and the second data.

11. The method of claim 10, wherein the combining step comprises combining the data to optimize reading of the data within the multiple actuator multiple disk system.

12. The method of claim 11, wherein combining the data to optimize reading of the data comprises combining the first predetermined portion of the data and the second predetermined portion of the data during reading of a third predetermined portion of the data from a disk surface of a disk of the multiple actuator multiple disk system using the first actuator and reading of a fourth predetermined portion of the data from a disk surface of a disk of the multiple actuator multiple disk system using the second actuator.

13. A method for reading read-data and writing write-data in a multiple actuator multiple disk system, each actuator comprising a plurality of actuator arms, each arm supporting a respective suspension at the end of which is one or more heads, wherein each head of one of the multiple actuators is positioned with respect to a respective disk surface of the multiple actuator multiple disk system such that the other actuator has no head in a vicinity of the respective surface, the method comprising:
receiving the write-data from a first interface;
receiving information on where the read-data is stored; and
writing the write-data onto a disk surface of a first disk of the multiple actuator multiple disk system using a first actuator of the multiple actuators coupled to the first interface while
reading the read-data from a second disk surface of a disk the multiple actuator multiple disk system using a second actuator of the multiple actuators coupled to the second interface.

14. The method of claim 13, wherein the first disk surface is different to the second disk surface.

15. The method of claim 14, wherein the first disk surface and second disk surface are opposed surfaces of a single disk in the multiple actuator multiple disk system.

16. The method of claim 13, wherein the writing step further comprises writing parity information onto any one or more of the disk surfaces of the multiple actuator multiple disk system, to facilitate reconstruction of data stored on any one or more of the surfaces.

17. The method of claim 16, wherein the parity information is determined such that data accuracy can be computed using a checksum routine.

18. The method of claim 17, wherein the checksum routine employs XOR computation.

19. The method of claim 13, wherein the data is written in a byte addressable and/or block addressable format.

20. The method of claim 6, wherein the data is read and written in a byte addressable and/or block addressable format.

21. The method of claim 13, wherein the step of reading further comprises reading parity information from any one or more of the surfaces of the multiple actuator multiple disk system, to facilitate reconstruction of data stored on any one or more of the surfaces.

22. The method of claim 21, wherein the data stored on any one or more of the surfaces is reconstructed using XOR computation of the parity information and one or more of the predetermined portions.

23. A single enclosure multi disk Hard Disk Drive (HDD) comprising:
a first disk surface;
a second disk surface;
a first actuator for writing to the first disk surface; and
a second actuator for writing to the second disk surface, the second actuator separately located and operating independently of the first actuator,
wherein each of the first actuator and second actuator comprises a plurality of actuator arms, each arm supporting a respective suspension at the end of which is one or more heads, wherein each head of one of the multiple actuators is positioned with respect to a respective disk surface of the multi disk HDD such that the other actuator has no head in a vicinity of the respective surface,
wherein a logical block address (LBA) for the first disk surface is assigned differently than a LBA for the second disk surface, such that the LBA for the second disk surface can be determined from the LBA for the first disk surface.

24. The single enclosure multi disk HDD in accordance with claim 23, wherein the second actuator is located 180 degrees from the first actuator and the predetermined LBA for the first disk is located 180 degrees from the corresponding predetermined LBA for the second disk.
